(19) United States
(12) Patent Application Publication
(10) Pub. No.: US 2015/0078009 A1
(43) Pub. Date: Mar. 19, 2015

(54) OPTICAL LENS AND LIGHT SOURCE MODULE HAVING THE SAME

(71) Applicant: HON HAI PRECISION INDUSTRY CO., LTD., New Taipei (TW)

(72) Inventors: CHAU-JIN HU, Tu-Cheng (TW); LI-YING WANG HE, Tu-Cheng (TW)

(73) Assignee: HON HAI PRECISION INDUSTRY CO., LTD., New Taipei (TW)

(21) Appl. No.: 14/060,625

(22) Filed: Oct. 23, 2013

(30) Foreign Application Priority Data
Sep. 18, 2013 (TW) 102134006

(51) Int. Cl. F21V 5/04

(52) U.S. Cl. CPC F21V 5/046
USPC 362/311.09; 362/335; 362/338; 362/311.06

(57) ABSTRACT

A light source module includes a light source and an optical lens facing the light source. The optical lens includes a light incident face facing the light source, a light emitting face opposite to the light incident face, and a connecting face connecting the light incident face and the light emitting face. The connecting face is planar. The light emitting face includes a lateral face extending upwardly from an outer periphery of the connecting face and a top face located above the light incident face. The top face of the light emitting face includes a center facet facing the light incident face, a first curved facet surrounding and connecting to the center facet, and a second curved facet surrounding and smoothly connecting to the first curved facet.

### BACKGROUND

1. Technical Field

The disclosure generally relates to optical lenses, and particularly relates to an optical lens to increase an illuminating angle of a light source and a light source module having the optical lens.

2. Description of Related Art

In recent years, due to excellent light quality and high luminous efficiency, light emitting diodes (LEDs) have increasingly been used as substitutes for incandescent bulbs, compact fluorescent lamps and fluorescent tubes as light sources of illumination devices.

Generally, light intensity of a light emitting diode gradually decreases from a middle portion to lateral sides thereof. Such a feature makes the LED unsuitable for functioning as a light source which needs a uniform illumination, for example, a light source for a direct-type backlight module for a liquid crystal display (LCD). It is required to have an optical lens which can help the light emitted from a light emitting diode to have a wider illuminating angle and a uniform intensity. Unfortunately, the conventional optical lens and a light source module having the conventional optical lens can not obtain a satisfactory effectiveness.

What is needed, therefore, is an improved optical lens and a light source module having the optical lens to overcome the above described disadvantages.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a light source module having an optical lens in accordance with an exemplary embodiment of the present disclosure.

FIG. 2 is an inverted view of the optical lens of the light source module in FIG. 1.

FIG. 3 is a cross section view of the light source module in FIG. 1, taken along a line III-III thereof.

### DETAILED DESCRIPTION

Embodiments of an optical lens and a light source module will now be described in detail below and with reference to the drawings.

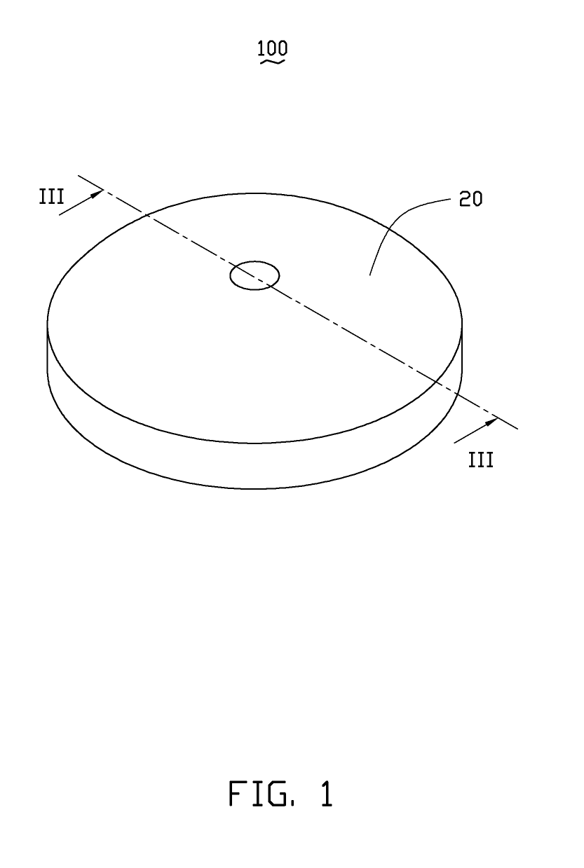

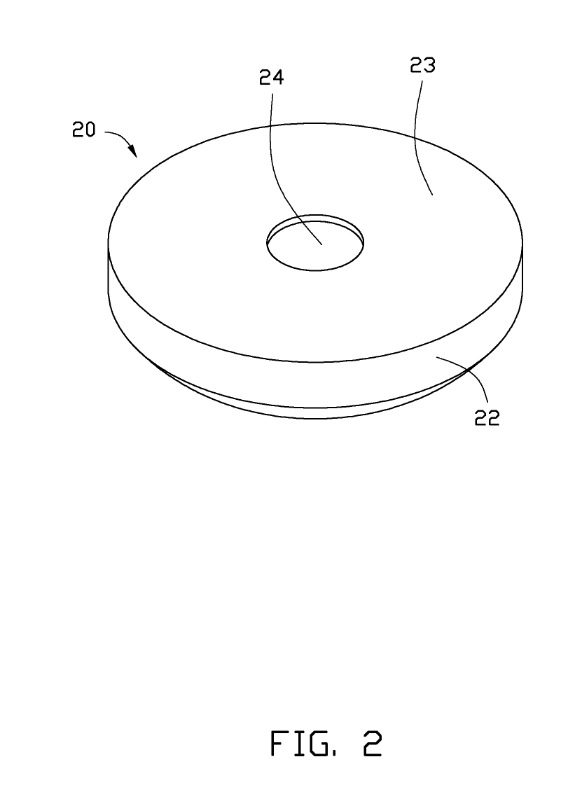

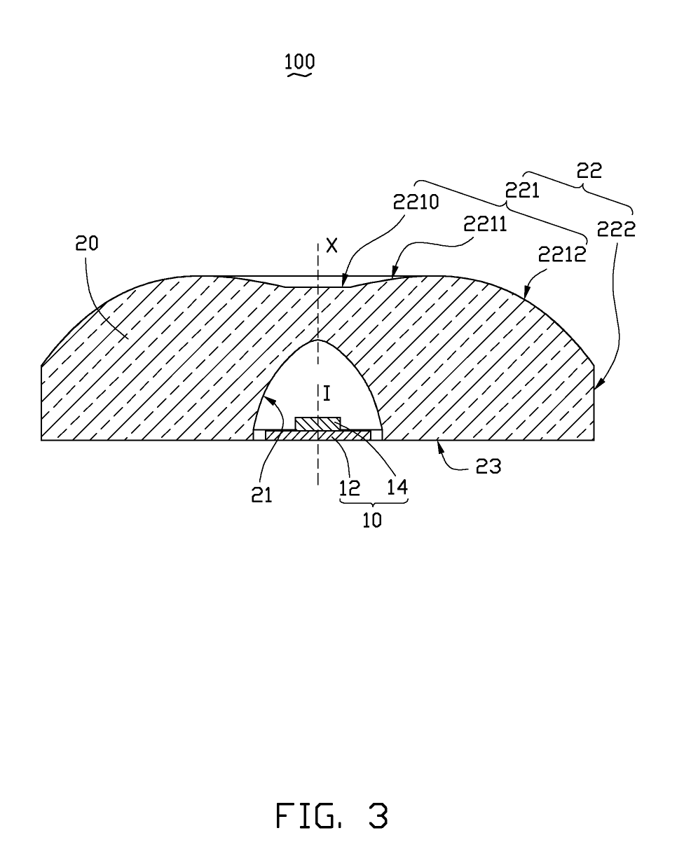

Referring to FIGS. 1 through 3, a light source module 100 in accordance with an exemplary embodiment of the disclosure is illustrated. The light source module 100 includes a light source 10 and an optical lens 20 covering the light source 10. The optical lens 20 includes a light incident face 21 facing the light source 10, a light emitting face 22 opposite to the light incident face 21, and a connecting face 23 connecting the light incident face 21 and the light emitting face 22. The light source 10 has an optical axis I, around which light emitted from the light source 10 concentrates in a surrounding space.

In this embodiment of the present disclosure, the light source 10 is a light emitting diode (LED), and includes a supporting base 12 and an LED chip 14 mounted on the supporting base 12. The supporting base 12 is flat. The supporting base 12 may be made of electrically-insulating materials such as epoxy, silicon or ceramic. The LED chip 14 may be made of semiconductor materials such as GaN, InGaN, AlInGaN or the like. Preferably, the LED chip 14 emits visible light when being activated.

The optical lens 20 is integrally made of transparent materials such as PC (polycarbonate), PMMA (polymethyl methacrylate) or optical glass. It could be understood, a plurality of fluorescence, such as YAG, TAG, silicate, nitride, nitrogen oxides, phosphide, arsenide, telluride or sulfide, could be further provided to mix in the optical lens 20.

The optical lens 20 is located above and spaced from the light source 10. A center of a bottom face of the optical lens 20 is recessed inwardly, whereby the light incident face 21 and a receiving space 24 for accommodating the light source 10 are formed. The connecting face 23 is an annular and planar face surrounding the light incident face 21. In use, the connecting face 23 is fitly attached on a supporting face (not shown) supporting the light source 10 and the optical lens 20. The optical lens 20 defines a central axis X, and the optical lens 20 is rotationally symmetrical relative to the central axis X. The central axis X of the optical lens 20 is aligned with the optical axis I of the light source 10. The light incident face 21 is a curved face and protrudes away from the light source 10. The light incident face 21 is a sculptured face, an ellipsoidal face, a spherical face or a paraboloidal face. The light incident face 21 is rotationally symmetrical relative to the central axis X. The light emitting face 22 is rotationally symmetrical relative to the central axis X.

The light emitting face 22 includes a lateral face 222 extending upwardly from an outer periphery of the connecting face 23 and a top face 221 located above the light incident face 21. The lateral face 222 is a cylindrical face. The top face 221 of the light emitting face 22 includes a center facet 2210 facing the light incident face 21, a first curved facet 2211 surrounding and connecting to the center facet 2210, and a second curved facet 2212 surrounding and smoothly connecting to the first curved facet 2211. The first curved facet 2211 is sculptured, ellipsoidal, spherical or paraboloidal. The first curved facet 2211 is rotationally symmetrical relative to the central axis X. The first curved facet 2211 protrudes toward the light incident face 21. The second curved facet 2212 protrudes away from the light incident face 21. The second curved facet 2212 is sculptured, ellipsoidal, spherical or paraboloidal. The second curved facet 2212 is rotationally symmetrical relative to the central axis X. An outer periphery of the second curved facet 2212 of the light emitting face 22 correspondingly meets the lateral face 222. The center facet 2210 of the top face 221 is planar or concave. The center facet 2210 is rotationally symmetrical relative to the central axis X.

In use, the light emitted from the light source 10 is entered into the optical lens 20 through the light incident face 21 and refracted, then transmitted in the optical lens 20, and exited and refracted from the center facet 2210, the first curved facet 2211 and the second curved facet 2212 of the top face 221, and the lateral face 222. The light is gradually diverged relative to the optical axis I of the optical lens 20, thus an illumination angle of the light source module 100 is widened and whereby the light source module 100 can illuminate more evenly.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An optical lens for adjusting light emitted from a light source, comprising:
a light incident face facing the light source;
a light emitting face opposite to the light incident face; and
a connecting face connecting the light incident face and the light emitting face;
wherein the connecting face is planar, and the light emitting face comprises a lateral face extending upwardly from an outer periphery of the connecting face and a top face located above the light incident face; and
wherein the top face of the light emitting face comprises a center facet facing the light incident face, a first curved facet surrounding and connecting to the center facet, and a second curved facet surrounding and smoothly connecting to the first curved facet.

2. The optical lens as claimed in claim 1, wherein a center of a bottom face of the optical lens is recessed inwardly, whereby the light incident face is formed.

3. The optical lens as claimed in claim 2, wherein the light incident face is a sculptured face, an ellipsoidal face, a spherical face or a paraboloidal face.

4. The optical lens as claimed in claim 1, wherein the center facet is planar.

5. The optical lens as claimed in claim 1, wherein the center facet is concave.

6. The optical lens as claimed in claim 1, wherein the first curved face protrudes toward the light incident face, and the second curved face protrudes away from the light incident face.

7. The optical lens as claimed in claim 6, wherein the first curved facet is sculptured, ellipsoidal, spherical or paraboloidal.

8. The optical lens as claimed in claim 6, wherein the second curved facet is sculptured, ellipsoidal, spherical or paraboloidal.

9. The optical lens as claimed in claim 1, wherein the optical lens defines a central axis, and the optical lens is rotationally symmetrical relative to the central axis.

10. The optical lens as claimed in claim 9, wherein the light incident face, the center facet, the first curved facet and the second curved facet of the top face are rotationally symmetrical relative to the central axis of the optical lens.

11. A light source module, comprising:
a light source; and
an optical lens covering the light source, and the optical lens comprising:
a light incident face facing the light source;
a light emitting face opposite to the light incident face; and
a connecting face connecting the light incident face and the light emitting face;
wherein the connecting face is planar, and the light emitting face comprises a lateral face extending upwardly from an outer periphery of the connecting face and a top face located above the light incident face; and
wherein the top face of the light emitting face comprises a center facet facing the light incident face, a first curved facet surrounding and connecting to the center facet, and a second curved facet surrounding and smoothly connecting to the first curved facet.

12. The light source module as claimed in claim 11, wherein a center of a bottom face of the optical lens is recessed inwardly, whereby the light incident face is formed.

13. The light source module as claimed in claim 12, wherein the light incident face is a sculptured face, an ellipsoidal face, a spherical face or a paraboloidal face.

14. The light source module as claimed in claim 11, wherein the center facet is planar.

15. The light source module as claimed in claim 11, wherein the center facet is concave.

16. The light source module as claimed in claim 11, wherein the first curved face protrudes toward the light incident face, and the second curved face protrudes away from the light incident face.

17. The light source module as claimed in claim 16, wherein the first curved facet is sculptured, ellipsoidal, spherical or paraboloidal.

18. The light source module as claimed in claim 16, wherein the second curved facet is sculptured, ellipsoidal, spherical or paraboloidal.

19. The light source module as claimed in claim 11, wherein the optical lens defines a central axis, and the optical lens is rotationally symmetrical relative to the central axis.

20. The light source module as claimed in claim 19, wherein the light incident face, the center facet, the first curved facet and the second curved facet of the top face are rotationally symmetrical relative to the central axis of the optical lens.
